(19) United States
(12) Patent Application Publication
(10) Pub. No.: US 2007/0072160 A1
(43) Pub. Date: Mar. 29, 2007

(54) Interactive healthcare e-learning tool

(75) Inventors: Kelly L. Jolly, Pekin, IL (US); Jonathan D. Ginzel, Peoria, IL (US); Vicky L. Cordani, Peoria, IL (US); Everett D. Renno, Morton, IL (US); Andrew J. Konsky, Washington, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/529,493

(22) Filed: Sep. 29, 2006

Related U.S. Application Data
(60) Provisional application No. 60/721,581, filed on Sep. 29, 2005.

(51) Int. Cl. G09B 23/28

(52) U.S. Cl. 434/262

(57) ABSTRACT

A computer system for a healthcare e-learning system is provided. The computer system has a platform, at least one input device, and a central processing unit in communication with the platform and the at least one input device. The central processing unit is configured to receive healthcare information about a user and determine a plurality of available healthcare e-learning topics according to the received healthcare information. The central processing unit is also configured to generate healthcare e-learning information for the user based on the determined topics and to provide at least one customized learning scenario to the user based on the received information. The central processing unit is further configured to enable the user to selectively navigate through the generated healthcare e-learning information.

### TECHNICAL FIELD

The present disclosure is directed to the field of healthcare and, more particularly, to an interactive healthcare e-learning tool.

### BACKGROUND

Healthcare has been increasing in both cost and business complexity over the past few decades. In response, individuals, providers, employers, and insurance carriers have been seeking ways to improve understanding of healthcare coverage including, for example, policy terms and cost. For instance, employers who offer healthcare benefits to employees have attempted to involve employees in taking an active role in healthcare decisions. While an employee or customer has unique healthcare needs, the ability of an individual to get involved and take an active role in healthcare decisions depends on the degree of knowledge or information possessed by the particular individual making the decision.

Healthcare decisions are usually made by employees or customers during the hiring process or during a predetermined time or “season” of the year. The process of decision making in a healthcare plan requires knowledge about healthcare plans and its corresponding costs, deductibles, limits, providers, and claim policies. By considering these aspects of healthcare, a customer or employee may make an informed decision. However, an individual's particular needs may be different, even in the same organization or business. Furthermore, healthcare users may have different degrees of prior knowledge, as well as different learning preferences and abilities. Without an appropriate tool, the process of learning how a particular healthcare system works may be a time-consuming experience.

One tool that has been developed for providing an interactive training is described in U.S. Pat. No. 6,535,713 (the '713 patent) issued to Houlihan et al. on Mar. 18, 2003. The '713 patent describes a tool that includes a lesson engine, a lesson delivery system, and a lesson authoring tool. The lesson engine runs an interactive training exercise based on a lesson file. The lesson delivery system displays a menu of lessons to a student, provides a lesson file corresponding to the student's selection, and invokes the lesson engine. The lesson file and multimedia content referenced in the lesson file are retrieved based on an input by a student. The lesson authoring tool provides a graphical interface for inputting and editing storyboards, from which the tool is configured for generating a lesson file.

Although the method of the '713 patent may provide interactive multimedia training, it may not provide a learning tool directed to healthcare users. In particular, because the lesson files and multimedia content in the '713 patent instruct the student, it may not provide a healthcare learning tool directed to the user's individualized needs. In particular, it may not provide healthcare information pertinent to a particular user, because the lesson files are previously generated by a lesson authoring tool, which does not consider different healthcare scenarios related to a healthcare user's particular needs.

The present invention is directed to overcoming the one or more problems or disadvantages associated with the prior art.

### SUMMARY OF THE INVENTION

In accordance with one aspect, the present disclosure is directed toward a computer readable medium, tangibly embodied, including an interactive healthcare e-learning tool. The computer readable medium includes instructions for receiving healthcare information about a user. The medium also includes instructions for determining a plurality of available healthcare e-learning topics according to the received healthcare information. The medium includes instructions for generating healthcare e-learning information for the user based on the determined topic and for providing at least one customized learning scenario to the user based on the received information. The medium further includes instructions for enabling the user to selectively navigate through the generated healthcare e-learning information.

According to another aspect, the present disclosure is directed toward a method for providing a healthcare e-learning tool to a user. The method includes receiving healthcare information about a user and determining a plurality of available healthcare e-learning topics according to the received healthcare information. The method also includes generating healthcare e-learning information for the user based on the determined topics and providing at least one customized learning scenario to the user based on the received information. The method further includes enabling the user to selectively navigate through the generated healthcare e-learning information.

### BRIEF DESCRIPTION OF THE DRAWINGS

FIG. 1 is a block illustration of an exemplary disclosed healthcare e-learning computer system;

FIG. 2 is a schematic illustration of a database included in the disclosed healthcare e-learning computer system;

FIG. 3 is a schematic illustration of an exemplary browser providing healthcare e-learning information to a user; and

FIG. 4 is a flowchart illustration of an exemplary disclosed method of operating the healthcare e-learning computer system.

### DETAILED DESCRIPTION

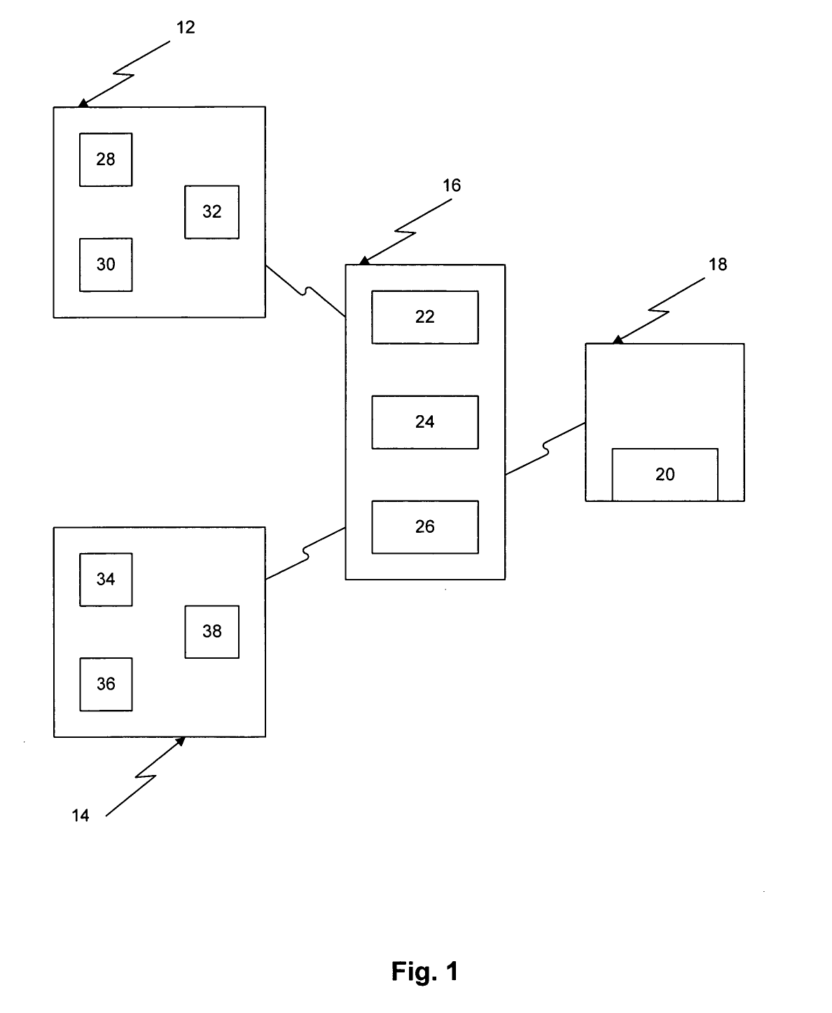

FIG. 1 illustrates a healthcare e-learning system 10. System 10 may include an input module 12, an output module 14, and a computing platform 16. Computing platform 16 may include or may be otherwise operatively coupled to a database 18, which may be stored in a memory 20. Database 18 may include more than one database or other type of electronic repository. Computing platform 16 may be adapted to include the necessary functionality and computing capabilities to implement healthcare e-learning strategies through input module 12 and access, read, and write to database 18.

The results of received data may be provided as output from computing platform 16 to output module 14 for printed display, viewing, and/or further communication to other system devices. Such output may include, for example, information packages, exercise results, or healthcare information obtained from the e-learning system for the user's reference. Output from computing platform 16 can also be provided to database 18, which may be utilized as a storage device for healthcare e-learning information for individual members, customers or employees.

In the embodiment of FIG. 1, computing platform 16 may include a personal (PC) or mainframe computer configured to perform various functions and operations. Computing platform 16 may be implemented, for example, by a general purpose computer selectively activated or reconfigured by a computer program stored in the computer, or may be a specially constructed computing platform for carrying out the features and operations of healthcare e-learning system 10. Computing platform 16 may also be implemented or provided with a wide variety of components or subsystems including, for example, one or more of the following: a processor 22, a co-processor 24, a register 26, and/or other data processing devices and subsystems. Computing platform 16 may also communicate or transfer healthcare e-learning strategies, exercises or questionnaires, and feedback by users to and/or from input module 12 and output module 14 through the use of direct connections or other communication links, as illustrated in FIG. 1. In an exemplary embodiment, a firewall may prevent access to the platform by unauthorized outside entities. It is further contemplated that platform 16 may require user authentication, such as password verification, in order to prevent unauthorized users from gaining access to healthcare information from a particular provider or employer.

It is further contemplated that communication between computing platform 16 and module 12 and module 14 can be achieved through the use of a network architecture (not shown). In such an embodiment, the network architecture may include, alone or in any suitable combination, a telephone-based network (such as a PBX or POTS), a local area network (LAN), a wide area network (WAN), a dedicated intranet, and/or the Internet. Further, the network architecture may include any suitable combination of wired and/or wireless components and systems. By using dedicated communication links or a shared network architecture, computing platform 16 may be located in the same location or at a geographically distant location from input module 12 and/or output module 14.

Input module 12 may include a wide variety of devices to receive and/or provide the data as input to computing platform 16. As illustrated in FIG. 1, input module 12 may include an input device 28, a storage device 30, and/or a network interface 32. Input device 28 may include a keyboard, mouse, touchscreen, disk drive, video camera, magnetic card reader, or any other suitable input device for providing customer, employee or member data to computing platform 16. Memory 20 may be implemented with various forms of memory or storage devices, such as read-only memory (ROM) devices and random access memory (RAM) devices. Storage device 30 may include a memory tape or disk drive for reading and providing data on a storage tape or disk as input to computing platform 16. Network interface 32 may be configured to receive data over a network (such as a LAN, WAN, intranet or the Internet) and to provide the same as input to computing platform 16. For example, network interface 32 may be connected to a public or private database over a network for the purpose of receiving information about users, such as employees, customers or members, from computing platform 16.

Output module 14 may include a display 34, a printer device 36, and/or a network interface 38 for receiving the results provided as output from computing platform 16. As indicated above, the output from computing platform 16 may include one or more information packages, exercise results, or healthcare information obtained from the e-learning system for the user's reference. The output from computing platform 16 may be displayed or viewed through display 34 (such as a CRT or LCD) and printer device 36. Network interface 38 may also be configured to facilitate the communication of the output from computing platform 16 over a network (such as a LAN, WAN, intranet or the Internet) to remote or distant locations for further analysis, viewing or storing.

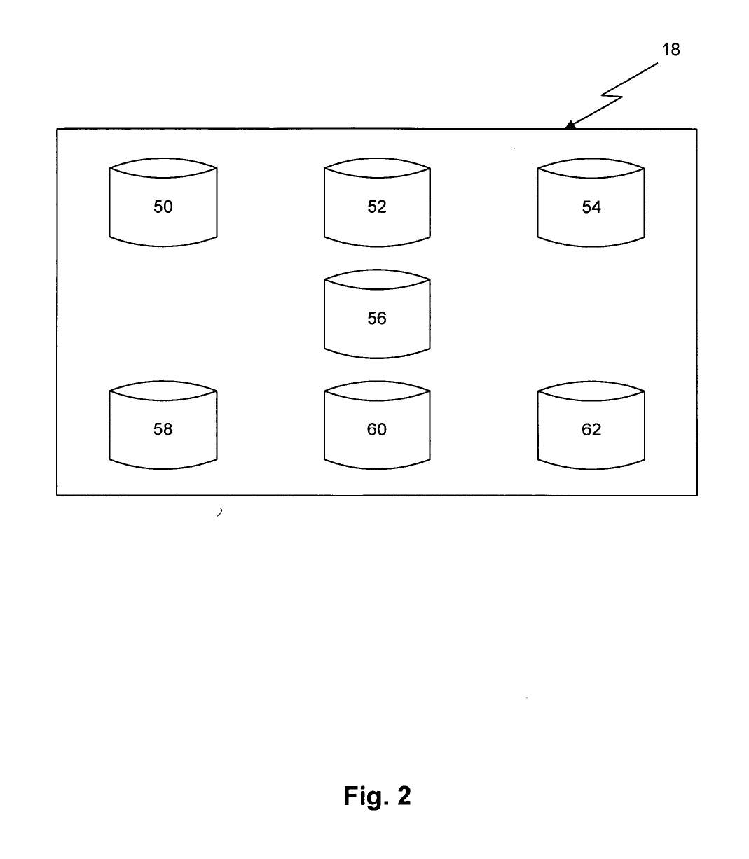

Healthcare e-learning information applicable to individual members, customers or employees may be stored in memory 20 in database 18. FIG. 2 illustrates one embodiment of database 18. Database 18 may include health-related information for a population of members, customers or employees. Database 18 may also include data relevant to the population of members, customers or employees as a whole and/or selected segments of the population. Database 18 may further include individual health-related data directed to individual members of the population. Such individual data may include various information that may impact or otherwise relate to different aspects of healthcare.

For example, database 18 may include introductory information 50, which may be furnished by the employer or healthcare provider. Introductory information 50 may provide an overview of topics included in the healthcare e-learning tool. Alternatively or additionally, introductory information 50 may include instructions or requirements for executing the healthcare e-learning tool. Introductory information 50 may also include an overview of objectives set by the employer or provider. For example, introductory information 50 may inform the user that the use of the healthcare e-learning tool may be directed at increasing consumer awareness by the user, increasing understanding of healthcare costs and coverage, or helping the user choose a healthcare plan that best suits his or her specific medical circumstances and financial needs. Other objectives that may be provided by introductory information 50 may include managing a family plan, understanding the terms of existing or prospective healthcare benefits, or compliance with necessary administrative procedures.

Database 18 may include other information, such as general information 52 about the how a particular healthcare plan works. For example, general healthcare information 52 may include information about how a particular healthcare plan is funded, as well as the level of involvement of different vendors and suppliers. General healthcare information 52 may also include description of how fees and premiums are paid by employees or customers, as well as how portions of healthcare cost are covered by for example, the employer. General healthcare information 52 may further include information about health insurance policies. For example, general healthcare information 52 may include information regarding insurance policies purchased by an employer from third parties, such as Health Maintenance Organizations (HMO) companies and how cost is allocated between the employer and the customer or employee, who received the benefit of healthcare.

General healthcare information 52 may also further include healthcare e-learning information including, for example, concepts and terminology relevant to a particular user and his or her needs. For example, general healthcare information 28 may include concepts and terminology such as premium, deductible, co-insurance, co-pay, and maximum out-of-pocket (MOOP) expenses.

General healthcare information 52 may include information regarding how a premium is set and paid by the user. Premiums may be revised and re-calculated every set period of time. General healthcare information 52 may provide information regarding the revision and calculation of healthcare premiums.

General healthcare information 52 may also provide information regarding deductibles and how they are calculated. For example, for a particular organization, business or user, a deductible may be a predetermined annual amount that must be paid by the user before a healthcare plan begins to make payments. General healthcare information 52 may also provide information regarding exceptions to these requirements. For example, it may indicate that a particular type of treatment of service is completely covered by an employer when obtained at predetermined network providers.

General healthcare information 52 may further provide information regarding co-insurance and how it applies to a particular healthcare plan. For example, co-insurance may refer to the amount or portion a user has to pay for most expenses covered by a particular healthcare plan.

General healthcare information 52 may further include information regarding co-pay. For a particular healthcare plan, co-pay may refer to a predetermined amount that must be paid by the user in order to receive certain covered services. For example, co-pay may refer to a predetermined amount that must be paid when receiving a covered prescription drug. General healthcare information 52 may further include information directed to educate the user regarding the relationship or differences between co-pays and deductibles.

General healthcare information 52 may additionally include information directed to educate the user regarding maximum out-of-pocket (MOOP) expenses. For example, MOOP may refer to a predetermined amount that, once reached within a calendar year, would indicate that an employer would be responsible for the totality of expenses in excess of the MOOP amount. General healthcare information 52 may further include information regarding what type of expenses and costs covered by the user are included in the calculation of the MOOP. For example, the calculation of the MOOP may include expenses such as deductibles and co-insurance expenses incurred by the user in a calendar year. General healthcare information 52 may include information regarding expenses that are not included in the calculation of the MOOP. For example, general healthcare information 52 may be directed to educate a user in terms of out-of-pocket expenses not included in the MOOP amount, which may include vision benefits, dental benefits, prescription drug co-pays, emergency room co-pays, and monthly premiums.

Database 18 may include other information, such as information relating to healthcare vendors 54. For example, healthcare vendor information 54 may include information about how a particular vendor administers activities of a healthcare benefit plan. For example, healthcare vendor information 54 may include information directed to educate a user regarding vendor administration of health plan eligibility requirements, changes in personal information (including dependents), flexible spending account claims, and prescription drug benefits. Healthcare vendor information 54 may also include information directed to educate the user regarding vendor responsibilities. Examples of vendor responsibilities may include providing quality customer service in a timely manner, abiding by contract agreements, understanding and applying healthcare benefits, communicating possible issues to the employer or provider, and providing recommendations for saving opportunities in their respective fields.

An exemplary source of vendors, specializing in their respective fields may include Fidelity Workplace Services. Exemplary sources of vendors specializing in medical records may include United Healthcare (UHC), Medstat, etc. An exemplary source of vendors specializing in pharmacy information may include Restat. Healthcare e-learning system 10 may also be configured to automatically obtain information from these and/or other vendors and their respective databases, which may be either public or private.

Database 18 may additionally include other information, such as information relating to healthcare claims 56. For example, healthcare claims information 56 may include information about how a particular vendor administers claims under a particular benefit plan. Administering claims under a healthcare plan may include processing the claim, applying plan benefits, and paying a healthcare provider.

Database 18 may further include information directed to educate users regarding employee cost sharing 58. For example, cost sharing information 58 may include sample plans, and corresponding sample benefit calculations. Sample benefit calculations may consider deductibles, co-insurance, expenses above MOOP, and expenses credited towards the calculation of MOOP. Employee cost sharing information 58 may include, for example, a sample benefit plan, characterized by a $200 deductible, $1,000 MOOP expenses, and 90/10 co-insurance for the allowed amount of covered medical expenses. Employee cost sharing information 58 may further provide user with a graphic representation, such as a table or chart, illustrating how several expenses are paid by the employer or the employee during a calendar year, according to the sample benefit plan conditions.

It is contemplated that employee cost sharing information 58 may include sample benefit plans and cost sharing graphic illustrations for individual, as well as family healthcare plans. For example, employee cost sharing information 58 may include a sample benefit program for a couple, having a $400 deductible, $2,000 MOOP expenses, and 80/20 co-insurance. Employee cost sharing information 58 may further provide a user with a graphic representation, such as a table or chart, illustrating how several expenses are paid by the employer, employee or spouse during a given calendar year, according to the sample benefit plan conditions.

Database 18 may further include information directed to educate users regarding dental benefits 60. For example, dental benefits information 60 may include information as to whether there is an established provider network for dental services. Dental benefits information 60 may also include learning material regarding maximum benefits covered per person, coverage of preventive care, maximum lifetime benefits, and coverage of fillings, crowns, bridges, orthodontia, and of basic dental work.

It is contemplated that dental benefits information 60 may include sample dental benefit plans and cost sharing graphic illustrations for individual, as well as for family healthcare plans. For example, dental benefits information 60 may include a sample benefit program for an individual, where an employer covers the totality of preventive care, 80% of basic dental fillings, 50% of crown bridges, and 50% of orthodontia. Sample dental benefit plans may further include maximum lifetime benefits and/or maximum benefits covered per person per calendar year. Dental benefits information 60 may further provide user with a graphic representation, such as a table, illustrating how several expenses are paid by the employer or employee during a given calendar year or during his or her lifetime, according to the sample dental benefit plan requisites. Dental benefits information 60 may further include terms and definitions applied by employer or provider in determining dental benefits. For example, dental benefits information 60 may educate user, indicating that cleaning and x-rays will be covered in their totality up to “usual and customary.” The term “usual and customary” may refer to the reasonable charge for a covered service, and may be defined by the geographical area. The scope of “usual and customary” may be determined by a national third-party company.

It is also contemplated that database 18 may include a self-checking module 62. For example, self-checking module 62 may include quizzes or tests. These quizzes or tests may be completed by a user upon completion of introduction information 50, general healthcare information 52, healthcare vendor information 54, healthcare claims information 56, and/or dental benefits information 60. Self-checking module 62 may include self-checking exercises to be completed by the user in the form of multiple choice, drag-and-drop options, matching terms, fill in the blanks, and/or true or false. Results of self-checking activities may be recorded by the healthcare e-learning system 10. These results may be stored locally, as part of computer platform 16 or remotely, as part of database 18. Alternatively, results of self-checking activities may not be recorded by the healthcare e-learning system 10 and instead may be displayed as feedback in platform 16 for the user's personal learning and benefit.

Self-checking module 62 may provide a survey to the user at the end of a section selected by the user or at the end of the healthcare e-learning session. The survey may provide an opportunity for the user to enter questions, comments, and/or recommendations proposing new healthcare topics or regarding current healthcare topics.

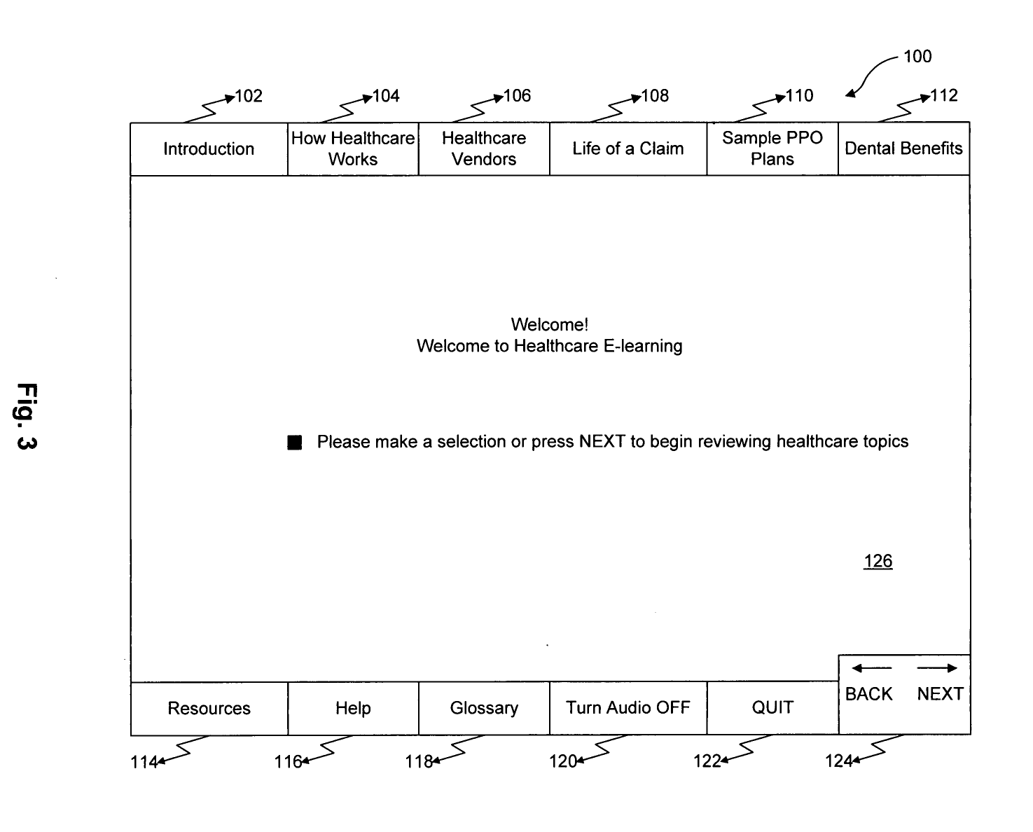

As illustrated in FIG. 3, system 10 may be configured to access, download, or otherwise gather various types of information from one or more sources. For example, information may be accessed from database 18 and be viewed via exemplary browser 100. Browser 100 may include information regarding introduction information 50, general healthcare information 52, healthcare vendor information 54, healthcare claims information 56, and/or dental benefits information 60 which may be stored in database 18. System 10 may be configured to develop and provide tailored learning packages and/or tailored questionnaires to users who are determined to share a particular condition or to have a particular healthcare need. System 10 may be configured to develop and provide tailored learning packages and/or tailored questionnaires to members whose family includes a particular number of member or to member whose healthcare needs require a particular type of information or treatment. System 10 may present the tailored healthcare information via browser 100.

An exemplary browser 100 provided to the user may include a plurality of navigational tools and multimedia content. Browser 100 may include options for viewing introductory information 102, information on how healthcare works 104, information regarding healthcare vendors 106, and learning material related to claim processing 108. Browser 100 may also provide information regarding sample healthcare plans 110. The healthcare examples available to a user by clicking or selecting section 110 may be tailored to a user's particular healthcare needs. For example, if a user is of a certain age, healthcare sample plans section 110 may include examples directed to healthcare needs characteristic of the age group. The user may have a particular family composition or may be married, in which case, section 110 may be configured to present sample healthcare plans including coverage for a spouse. It is also contemplated that user healthcare information may be obtained or modified according to prior or related survey results (referring to FIG. 2).

Exemplary browser 100 may further include information related to dental benefits 112, employee or customer resources 114, a help section 116, and a glossary section 118, including for example, healthcare terminology. Browser 100 may include multimedia controls, such as a section for selecting audio to be played during the e-learning session 120. Browser 100 may further include a section providing a user with the alternative of quitting the e-learning tool (section 122) during execution. Browser 100 may further provide controls for selecting (section 124) display of previous e-learning healthcare content 126 or selecting subsequent content, according to the healthcare e-learning session.

It is further contemplated that system 10 may be configured to obtain user healthcare information from database 18 and/or other databases, which may be either public or private. This information may be obtained in order to develop, deliver, and/or execute healthcare content tailored to a user's particular needs.

The described implementation may include a particular network configuration but embodiments of the present disclosure may be implemented in a variety of data communication network environments using software, hardware, or a combination of hardware and software to provide the processing functions.

Those skilled in the art will appreciate that all or part of systems and methods consistent with the present disclosure may be stored on or read from other computer-readable media. System 10 may include a computer-readable medium having stored thereon machine executable instructions for performing, among other things, the methods disclosed herein. Exemplary computer readable media may include secondary storage devices, like hard disks, floppy disks, and CD-ROM; a carrier wave received from the Internet; or other forms of computer-readable memory, such as read-only memory (ROM) or random-access memory (RAM). Such computer-readable media may be embodied by one or more components of system 10, such as, for example, computing platform 16, database 18, memory 20, processor 22, or combinations of these and/or other components.

Furthermore, one skilled in the art will also realize that the processes illustrated in this description may be implemented in a variety of ways and include multiple other modules, programs, applications, scripts, processes, threads, or code sections that may all functionally interrelate with each other to accomplish the individual tasks described above for each module, script, and daemon. For example, it is contemplated that these programs modules may be implemented using commercially available software tools, using custom object-oriented code written in the C++ programming language, using applets written in the Java programming language, or may be implemented as with discrete electrical components or as one or more hardwired application specific integrated circuits (ASIC) custom designed for this purpose.

The questionnaires and/or health-related information packages may include paper documents, electronic documents, Internet-based documents, and any other suitable media for documentation. The packages may include electronic documents, such as computer files. Such files may be administered to members of the target population via various modes of transmission, such as email. Internet-based documents may include word processor type files and/or webpages, which may include the health-related information and/or questionnaires. Administration of such documents may include notifying members in any suitable way of the availability and/or accessibility of such documents, including updated to existing content, and may provide an Internet address for accessing the documents.

Implementation of the disclosed system may be, to some extent, undertaken by hand. For example, the determination of which questions and/or information will be administered to individual members of the target population and/or the assembly of questionnaires may be handled by one or more persons, e.g., managers or administrators of the healthcare system. It is contemplated, however, that either a manual, semi-computerized, or fully computerized implementation may be utilized.

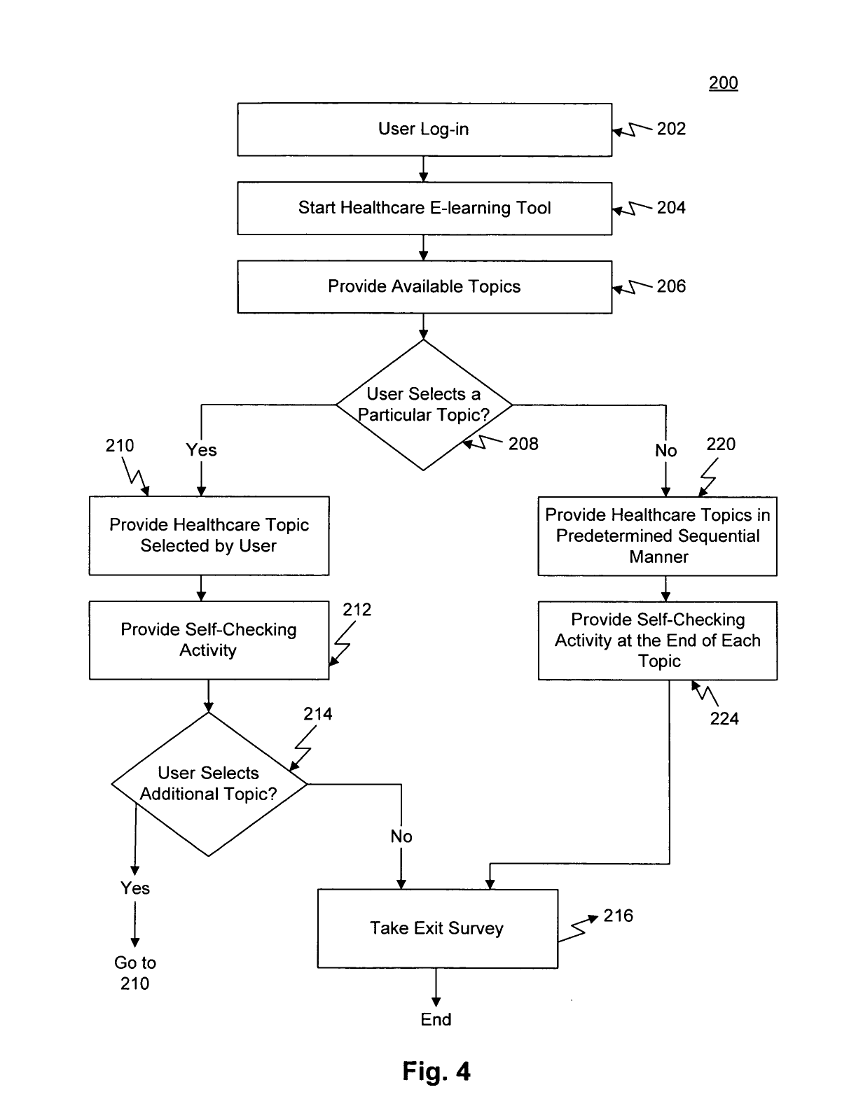

FIG. 4 illustrates a flowchart 200 depicting an exemplary method that utilizes a healthcare learning system 10 to provide a healthcare e-learning tool to a user. The method depicted in flowchart 200 will be described in more detail below.

### INDUSTRIAL APPLICABILITY

The disclosed method and system may provide a healthcare e-learning tool for subscribers or employees. In particular, the disclosed method and system may be used to implement an interactive e-learning healthcare tool based on a user's particular healthcare needs. In this manner, an employee who currently receives benefits or a prospective employee who is in the hiring process may be educated about the terms of a particular healthcare plan. The user of the healthcare e-learning tool may then make an informed decision when selecting, changing, or modifying healthcare coverage.

As illustrated in FIG. 4, the first step in the functioning of the healthcare e-learning tool may include a log-in procedure for the user of the healthcare e-learning system (Step 202). The log-in procedure may be completed via input module 12, including input device 28. During log-in, a user may have also enter personal information related to particular healthcare aspects, such as, for example, number of family members, age, and marital status.

Upon receipt and verification of log-in information, a healthcare e-learning tool may be initialized (Step 204). Healthcare e-learning tool may be tailored to the particular user according to the information provided as part of the log-in procedure. The user may then be presented with multiple flow paths selectable by the user, including, for example, introduction information, general healthcare information, healthcare vendor information, healthcare claims information, sample healthcare plans information, and/or dental benefits information (Step 206). The user may be given the alternative to select a particular healthcare topic for access and/or review (Step 208).

If the user desires to review or explore only certain topics contained within the tool, such as, for example, sample healthcare plans, healthcare e-learning tool may the provide information relating to the particular selection (Step 210). For example, if a married user selects to review information related to sample healthcare plans, and had indicated during log-in that he or she has a spouse, healthcare e-learning tool may provide a sample healthcare plan including calculations for spousal benefits and examples of cost allocation. For example, the user may be provided with a sample healthcare plan comprising a $400 deductible ($200 individual), $2,000 MOOP and 80/20 co-insurance for the allowed amount of coverage expenses.

As part of the selected topic, the user may then be provided with examples regarding sample healthcare services during a calendar year. For example, healthcare e-learning tool may provide the user with a sample cost-sharing scenario in which in January, a spouse received services for a value of $200; in February, the employee received services for a value of $200; in March, the employee received services for a value of $2,000; and in December, a spouse received services for a value of $100.

According to the example, the $200 expense incurred by the spouse in January may cover the individual deductible. This may then be paid by the employee, according to the healthcare plan terms. The $200 expense incurred by the employee in February may cover the individual deductible. This may also be paid by the employee. According to the healthcare plans, at this point, the employer may not be responsible for any expenses. For the $2,000 expense incurred by the employee in March, this may trigger the healthcare benefit, under the 80/20 co-insurance terms. For example, in this sample scenario, the employee may be responsible for $400 (or 20% of the expenses) while the employer may pay $1600 (or 80% of the expenses). In December, for the $100 expense incurred by the spouse, having covered the individual deductible for the year, the 80/20 co-insurance term may be triggered. In this sample scenario, the spouse may be responsible for $20 (or 20% of the expenses) while the employer may pay $80 (or 80% of the expenses). This information may be presented in an interactive format, including a sample table or other graphic representation, for aiding the user in reviewing the content of the sample healthcare plan information.

At the end of the presentation relating to the particular selection made by the user, healthcare e-learning tool may then provide a self-checking activity relating to the healthcare topic recently reviewed by the user (Step 212). The self-checking activity may include quizzes or tests to be completed by the user in the form of multiple choice, drag-and-drop options, matching terms, fill in the blanks, and/or true or false. For example, the user may be provided with a sample healthcare plan, including a given deductible, MOOP, and fractional co-insurance and be asked to complete or answer a particular exercise. Results of self-checking activities may then be recorded and locally or remotely stored. Alternatively, results of self-checking activities may not be recorded by the healthcare e-learning tool and instead may be displayed as feedback for the user's personal information and benefit.

Having completed the selected topic, the user may then be given the alternative of selecting an additional healthcare topic for review (Step 214). If the user decides to review another healthcare topic, healthcare e-learning tool may direct the user to the selected information (Step 210). If no additional healthcare topic is selected for review, the user may be asked to complete an exit survey (Step 216). The exit survey may provide an opportunity for the user to enter questions, comments, and/or recommendations proposing new healthcare topics or regarding current healthcare topics.

If the user instead decides not to select a particular healthcare topic for review (at Step 208), healthcare e-learning tool may the provide healthcare information in a predetermined sequential manner, covering all the topics included (Step 220). After completing review of each topic of the healthcare information, the user may be provided with a corresponding self-checking activity (Step 224). Having completed review of the information comprised in the healthcare e-learning tool, the user may be asked to complete an exit survey (Step 216).

It will be apparent to those skilled in the art that various modifications and variations can be made to the method and system of the present disclosure. Other embodiments of the method and system will be apparent to those skilled in the art from consideration of the specification and practice of the method and system disclosed herein. It is intended that the specification and examples be considered as exemplary only, with a true scope of the disclosure being indicated by the following claims.

What is claimed is:

1. A computer-readable medium, tangibly embodied, including an interactive healthcare e-learning tool, the computer-readable medium comprising instructions for:
receiving healthcare information about a user;
determining a plurality of available healthcare e-learning topics according to the received healthcare information;
generating healthcare e-learning information for the user based on the determined topics;
providing at least one customized learning scenario to the user based on the received information; and
enabling the user to selectively navigate through the generated healthcare e-learning information.

2. The computer-readable medium of claim 1, wherein:
the received healthcare information from the user includes at least one of: age, marital status, current or past medical conditions, and number of family members.

3. The computer-readable medium of claim 1, wherein the generated healthcare e-learning information includes information relating to at least one of: introductory data, general healthcare overview, vendors, healthcare claims, sample healthcare plans, and dental benefits.

4. The computer-readable medium of claim 1, further including instructions for:
providing a self-checking activity to the user after reviewing predetermined portions of the healthcare e-learning information.

5. The computer-readable medium of claim 1, wherein the at least one customized scenario includes sample healthcare plan information.

6. The computer-readable medium of claim 1, wherein the received information is entered by a user as part of a log-in procedure.

7. The computer-readable medium of claim 1, wherein the received information is automatically obtained from a database.

8. A method for providing a healthcare e-learning tool to a user, comprising:
receiving healthcare information about a user;
determining a plurality of available healthcare e-learning topics according to the received healthcare information;
generating healthcare e-learning information for the user based on the determined topics;
providing at least one customized learning scenario to the user based on the received information; and
enabling the user to selectively navigate through the generated healthcare e-learning information.

9. The method of claim 8, wherein the received healthcare information from the user includes at least one of: age, marital status, current or past medical conditions, and number of family members.

10. The method of claim 8, wherein the generated healthcare e-learning information includes information relating to at least one of: introductory data, general healthcare overview, vendors, healthcare claims, sample healthcare plans, and dental benefits.

11. The method of claim 8, further including:
providing a self-checking activity to the user after reviewing predetermined portions of the healthcare e-learning information and displaying feedback according to responses by the user.

12. The method of claim 8, wherein the at least one customized scenario includes sample healthcare plan information.

13. The method of claim 8, wherein the received information is entered by a user as part of a log-in procedure.

14. The method of claim 8, wherein the received information is automatically obtained from a database.

15. A computer system, comprising:
a platform;
at least one input device; and
a central processing unit in communication with the platform and the at least one input device, the central processing unit configured to:
receive healthcare information about a user;
determine a plurality of available healthcare e-learning topics according to the received healthcare information;
generate healthcare e-learning information for the user based on the determined topics;
provide at least one customized learning scenario to the user based on the received information; and
enable the user to selectively navigate through the generated healthcare e-learning information.

16. The computer system of claim 15, wherein the received healthcare information from the user includes at least one of: age, marital status, current or past medical conditions, and number of family members.

17. The computer system of claim 15, wherein the generated healthcare e-learning information includes information relating to at least one of: introductory data, general healthcare overview, vendors, healthcare claims, sample healthcare plans, and dental benefits.

18. The computer system of claim 15, wherein the central processing unit is further configured to:
provide a self-checking activity to the user after reviewing predetermined portions of the healthcare e-learning information and display feedback according to responses by the user.

19. The computer system of claim 15, wherein:
at least one customized scenario includes sample healthcare plan information.

20. The computer system of claim 15, wherein:
the received information is entered by a user as part of a log-in procedure or automatically obtained from a database.
